(19) United States
(12) Patent Application Publication
(10) Pub. No.: US 2005/0280950 A1
(43) Pub. Date: Dec. 22, 2005

(54) Head drum assembly for magnetic recording/reproducing apparatus

(75) Inventors: Myoung-joon Kim, Suwon-si (KR); Hyeong-seok Choi, Suwon-si (KR); Jeoung-seon Kim, Suwon-si (KR); Jae-hoon Sim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/152,339

(22) Filed: Jun. 15, 2005

(30) Foreign Application Priority Data
Jun. 16, 2004 (KR) 2004-44352

(51) Int. Cl. G11B 5/52

(52) U.S. Cl. 360/271.8

(57) ABSTRACT

A head drum assembly for a magnetic recording/reproducing apparatus includes a shaft on which a rotary drum is rotatably supported, and a fixed drum firmly fixed to the shaft and supported on a main deck. The fixed drum includes a fixed drum body facing the rotary drum and a fastening part extending from a lower side of the fixed drum body. The fastening part is supported by the main deck. A flange part extends from an outer circumference of the fastening part and is coupled to the main deck by screws.

### CROSS-REFERENCE TO RELATED APPLICATIONS

This application claims the benefit under 35 U.S.C. § 119(a) of Korean Patent Application Serial No. 2004-44352 filed on Jun. 16, 2004, the entire disclosure of which is hereby incorporated by reference.

### BACKGROUND OF THE INVENTION

1. Field of the Invention

The present invention relates to a head drum assembly for a magnetic recording/reproducing apparatus. More particularly, the present invention relates to a head drum assembly with a reduced number of parts.

2. Description of the Related Art

In general, magnetic recording/reproducing apparatuses record information on, or reproduce recorded information from, a recording medium such as a magnetic tape. Examples of such apparatuses include video cassette tape recorders (VCRs) and camcorders.

A magnetic recording/reproducing apparatus generally includes a deck, a head drum assembly rotatably installed on the deck for recording information on or reproducing recorded information from a magnetic tape, and a guide means for guiding the travel of the magnetic tape past the head drum assembly.

For higher recording/reproducing efficiency, the head drum assembly is usually positioned such that the head drum assembly rotates at a predetermined angle with respect to the main deck. FIG. 1 shows one example of such a head drum assembly. The head drum assembly includes a fixed drum 11 which is firmly fixed to a shaft 10. A rotary drum 13 is rotatably disposed on the upper part of the fixed drum 11. A drum cover 14 is firmly fixed to the upper part of the rotary drum 13. A magnetic head 15 is supported by the rotary drum 13 and causes magnetic signals to be recorded and reproduced from a running magnetic tape.

The magnetic head 15 contacts the magnetic tape when the magnetic tape runs on the outer circumference of the fixed drum 11 and the rotary drum 13, and accordingly records or reproduces data on the magnetic tape.

A fastening part 11a is provided at a lower side of the fixed drum 11. The fastening part 11a is for coupling the fixed drum 11 to the main deck 16. Screws 17 fasten the fastening part 11a to the main deck 16. An elastic member 18 may be disposed between the screws 17 and the main deck 16. The elastic member 18 prevents deformation of the head drum assembly by the fastening force of the screw 17.

In this type of conventional head drum assembly, separate, additional, parts such as the elastic member 18 are required. This increases the number of parts in the head drum assembly, and consequently, increases the number of assembly operations, as well as costs, associated with the head drum assembly.

Accordingly, there is a need for a head drum assembly with a reduced number of parts and lower cost.

### SUMMARY OF THE INVENTION

An aspect of the present invention is to solve at least the above-mentioned problems and/or disadvantages and to provide at least the advantages described below. Accordingly, an aspect of the present invention is to provide a head drum assembly for a magnetic recording/reproducing apparatus which can be firmly coupled to the apparatus by a reduced number of parts.

According to an aspect of the present invention, a head drum assembly for a magnetic recording/reproducing apparatus includes a shaft on which a rotary drum is rotatably supported. A fixed drum is firmly fixed to the shaft and is supported by a main deck. The fixed drum includes a fixed drum body facing the rotary drum, a fastening part extending from a lower side of the fixed drum body and supported on the main deck, and a flange part extending from an outer circumference of the fastening part and coupled to the main deck by at least one screw.

Preferably, the flange part is stepped with respect to a lower side of the fastening part.

It is also preferable that the flange part extends outwardly beyond the outer circumference of the fastening part. Also, preferably, the flange part extends outwardly the same distance as, or less than, the outer circumference of the fixed drum.

Also, it is preferable that the flange part has a plurality of screw holes which are provided in an area outside of a diameter of the fastening part.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a cross-sectional view of a conventional head drum assembly for a magnetic recording/reproducing apparatus;

FIG. 2 is a cross-sectional view of a head drum assembly of a magnetic recording/reproducing apparatus according to an embodiment of the present invention; and

FIG. 3 is a perspective view of a fixed drum of a head drum assembly of a magnetic recording/reproducing apparatus according to another embodiment of the present invention.

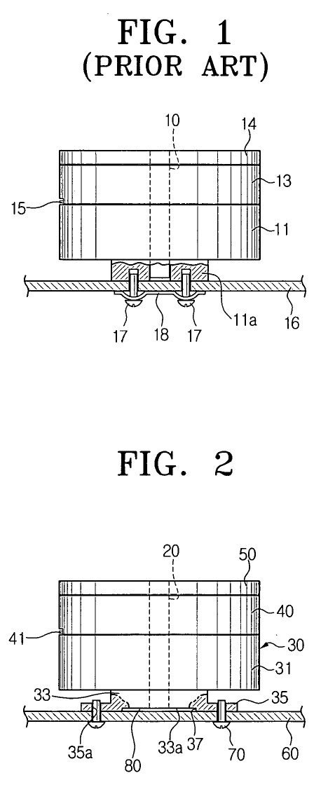

Throughout the drawings, the same drawing reference numerals will be understood to refer to the same elements, features, and structures

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Referring to FIG. 2, a head drum assembly of a magnetic recording/reproducing apparatus according to an embodiment of the present invention includes a fixed drum 30 firmly fixed to a shaft 20, a rotary drum 40 rotatably disposed on the upper part of the fixed drum 30, and a drum cover 50 disposed on the upper side 6f the rotary drum 40.

The shaft 20 is preferably force-fit in the fixed drum 30. The rotary drum 40 is rotatably supported by a bearing (not shown) on the shaft 20. The rotary drum 40 supports a magnetic head 41. The magnetic head records information on or reproduces recorded information from a magnetic tape.

The drum cover 50 supports elements such as a rotary transfer (not shown) for transferring information read by the magnetic head 41. The drum cover 50 is also firmly fixed to the shaft 20.

A motor (not shown) is provided between the fixed and rotary drums 30 and 40. The motor supplies rotational force to the rotary drum 40. The construction of the motor is well known, and therefore a detailed description is omitted for conciseness and clarity.

The fixed drum 30 is mounted on the main deck 60. The fixed drum 30 includes a fixed drum body 31 corresponding in shape with the rotary drum 40, a fastening part 33 extending from the lower part of the fixed drum body 31, and a flange part 35 extending from the outer circumference of the fastening part 33.

The fastening part 33 extends from the lower side of the body 31 by a predetermined distance, and has a diameter smaller than that of the body 31.

The flange part 35 extends from the lower side of the outer circumference of the fastening part 33. More specifically, the flange part 35 extends from the lower boundary of the fastening part 33 outwardly away from the shaft 20. Accordingly, with reference to the shaft 20, the flange part 35 extends further outwardly than the fastening part 33. Preferably, the flange part has an outer diameter equal to, or smaller than that of the body 31. The flange part 35 has a plurality of screw holes 35a for coupling with screw 70. The screw holes 35a are preferably provided at an area outside of the diameter of the fastening part 33. By doing so, the fastening force of the screw 70 is not directly transmitted to the fastening part 33. Instead, it is absorbed at the flange part 35.

A stepped part 37 may be provided between the lower side 33a of the fastening part 33 and the flange part 35. The stepped part 37 defines a space 80 between the fastening part 33 and the main deck 60. Accordingly, the fastening part 33 does not directly contact the main deck 60, and the fastening force of the screw 70 is prevented from being transmitted to the fastening part 33 and the body 31 via the main deck 60. Preferably, the flange part 35 is integrally formed with the fastening part 33 and is formed of a metal material.

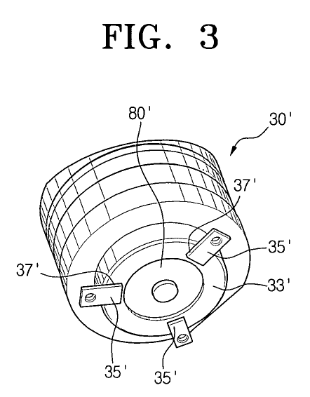

According to another aspect of the present invention, as shown in FIG. 3, a plurality of flange parts 35′ may be formed on the fastening part 33′ of the fixed drum 30′. The flange parts 35′ are discontinuous and define stepped parts 37′. The stepped parts 37′ form a recessed portion between each of the flange parts 35′. When mounted on a main deck, the recessed portion forms a space 80′ located between the lower side of the fastening part 33′ and the main deck. Preferably, the flange parts 35′ are spaced from each other at a regular interval, and each has a screw hole 35a′.

In a head drum assembly for a magnetic recording/reproducing apparatus built in accordance with the principles of the present invention (which has been discussed above with respect to a few exemplary embodiments), the fastening part does not directly contact the main deck because a flange part extends from the lower side of the fixed drum. Accordingly, the fastening force of the screw is generally absorbed in the flange part and is not directly transmitted to the fixed drum body and the rotary drum. Additionally, because the flange part is integrally formed with the fixed drum, the number of required parts is reduced without affecting the product. As a result, the cost decreases.

While the invention has been shown and described with reference to certain embodiments thereof, it will be understood by those skilled in the art that various changes in form and details may be made therein without departing from the spirit and scope of the invention as defined by the appended claims.

1. A head drum assembly for a magnetic recording/reproducing apparatus comprising:
a shaft on which a rotary drum is rotatably supported; and
a fixed drum firmly fixed to the shaft and supported on a main deck, the fixed drum comprising,
a fixed drum body facing the rotary drum,
a fastening part extending from a lower side of the fixed drum body and supported on the main deck, and
a flange part extending from an outer circumference of the fastening part, the flange part being coupled to the main deck by a screw.

2. The head drum assembly of claim 1, wherein the flange part is stepped with respect to a lower side of the fastening part.

3. The head drum assembly of claim 1, wherein the flange part extends outwardly beyond the outer circumference of the fastening part.

4. The head drum assembly of claim 3, wherein the flange part extends outwardly at a distance less than or equal to the outer circumference of the fixed drum.

5. The head drum assembly of claim 4, wherein the flange part has a plurality of screw holes which are provided at an area outside of a diameter of the fastening part.

6. The head drum assembly of claim 2, wherein the flange part extends outwardly beyond the outer circumference of the fastening part.

7. The head drum assembly of claim 6, wherein the flange part extends outwardly at a distance less than or equal to the outer circumference of the fixed drum.

8. The head drum assembly of claim 7, wherein the flange part has a plurality of screw holes which are provided at an area outside of a diameter of the fastening part.

9. The head drum assembly of claim 1, wherein the flange part is integrally formed with the fastening part.

10. A head drum assembly for a magnetic recording/reproducing apparatus comprising:
a shaft;
a rotary drum rotatably mounted to the shaft; and
a fixed drum firmly fixed to the shaft and supported on a main deck, the fixed drum comprising,
a fixed drum body facing the rotary drum,
a fastening part extending from a lower side of the fixed drum body, and
a plurality of flange parts extending from an outer circumference of the fastening part, the flange parts forming a space located between a lower side of the fastening part and the main deck, the flange part being fastened to the main deck by screws.

11. The head drum assembly of claim 10, wherein the flange part extends outwardly beyond the outer circumference of the fastening part.

12. The head drum assembly of claim 11, wherein the flange part extends outwardly at a distance less than or equal to the outer circumference of the fixed drum.

13. The head drum assembly of claim 10, wherein the flange parts are integrally formed with the fastening part.
